(19) United States
(12) Patent Application Publication
(10) Pub. No.: US 2011/0065022 A1
(43) Pub. Date: Mar. 17, 2011

(54) SOLID OXIDE FUEL CELL

(76) Inventors: Kyong Bok Min, Gyunggi-do (KR); Jae Hyuk Jang, Gyunggi-do (KR); Han Wool Ryu, Gyunggi-do (KR); Sung Han Kim, Seoul (KR)

(21) Appl. No.: 12/610,138

(22) Filed: Oct. 30, 2009

(30) Foreign Application Priority Data
Sep. 14, 2009 (KR) 10-2009-0086589

(51) Int. Cl. H01M 8/10

(52) U.S. Cl. 429/497

(57) ABSTRACT

Disclosed herein is a solid oxide fuel cell, including: one or more unit cells, each being provided with a ceramic tubular support; a metal layer which is formed on an outer circumference of one end of each of the unit cells and collects a first electric current; a metal foam which is formed in each of the unit cells and collects a second electric current; and a manifold which is connected with one end of each of the unit cells to receive the first current collected in the metal layer and which is connected with the other end of each of the unit cells to receive the second current collected in the metal foam. The solid oxide fuel cell is advantageous in that since the metal foam and metal tube are employed, an additional current collector is not required, and the electric current generated from an internal electrode can be easily collected through a manifold by connecting the metal foam and metal tube with the manifold.

### CROSS REFERENCE TO RELATED APPLICATION

This application claims the benefit of Korean Patent Application No. 10-2009-0086589, filed Sep. 14, 2009, entitled “solid oxide fuel cell”, which is hereby incorporated by reference in its entirety into this application.

### BACKGROUND OF THE INVENTION

1. Technical Field

The present invention relates to a solid oxide fuel cell.

2. Description of the Related Art

A fuel cell is an apparatus for directly converting the chemical energy of a fuel (hydrogen, LNG, LPG or the like) and air into electric energy and thermal energy through an electrochemical reaction. Differently from conventional electric power systems operated by the procedures of burning fuel, generating steam, driving a turbine and driving an electric generator, a fuel cell has high efficiency and does not cause environmental problems because it does not require a fuel burning procedure nor a driving device. Such a fuel cell is advantageous in that it scarcely emits air pollutants, such as Sox, NOx and the like, and generates a small amount of carbon dioxide, thus realizing pollution-free energy generation, and in that it is low noise and does not vibrate.

Meanwhile, there are various kinds of fuel cells, such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and the like. Among them, the solid oxide fuel cell (SOFC) has high power generation efficiency because its overvoltage is low due to activation polarization and its irreversible loss is small. Further, the solid oxide fuel cell (SOFC) can use a wide selection of fuels because carbon and hydrocarbons as well as hydrogen can be used, and does not need expensive precious metals as an electrode catalyst because the reaction rate at the electrodes is high. Moreover, heat emitted from the solid oxide fuel cell (SOFC) according to power generation has a high use value because its temperature is very high. Furthermore, heat generated from the solid oxide fuel cell (SOFC) is not only used to reform fuel but also can be used as an industrial or warming energy source in the combined heat and power generation. Therefore, the solid oxide fuel cell (SOFC) is a power generating technology that is necessary for going into the hydrogen economy of the future.

Referring to the operating principle of a solid oxide fuel cell (SOFC), basically, the solid oxide fuel cell (SOFC) is an apparatus for generating power using the oxidation reaction of hydrogen and carbon monoxide (CO), and electrode reactions, represented by Reaction Formula 1, are conducted at the anode and cathode thereof.

Anode:H₂+O²⁻→H₂O+2e⁻

CO+O²⁻→CO₂+2e⁻

Cathode:O₂+4e⁻→2O²⁻

Total reaction:H₂+CO+O₂→H₂0+CO₂ [Reaction Formula 1]

That is, electrons reach a cathode through an external circuit, and simultaneously oxygen ions generated from the cathode are transferred to an anode through an electrolyte. Thus, in the anode, hydrogen and carbon monoxide (CO) are bonded with oxygen ions to produce electrons, water and carbon dioxide (CO₂).

Owing to the movement of electrons, electric current is produced from the solid oxide fuel cell. In particular, a tubular solid oxide fuel cell must be wired with a nickel (Ni) wire, a silver (Ag) wire or the like throughout the interior and exterior thereof in order to collect electric current. However, the wiring process is disadvantageous in that it is complicated and is expensive to implement. Particularly, it is very difficult to handle the internal current collection of the fuel cell.

FIG. 1 is a view showing a conventional internal current collecting method of a tubular solid oxide fuel cell.

As shown in FIG. 1, in the conventional internal current collecting method of a tubular solid oxide fuel cell, first, a nickel felt or nickel mesh 11 is welded with nickel wires 12 and then rolled round to have a form which can be inserted into a fuel cell. Subsequently, the roundly rolled nickel felt 13 is coated on the outer surface thereof with nickel ink 14, and then inserted into a fuel cell 15 to collect electric current.

However, the above-mentioned internal current collecting method requires cumbersome and complicated processes, such as a process of welding the nickel felt 11 with the nickel wires 12, a process of coating the nickel felt 11 with nickel 14 and the like. Further, it is difficult to confirm whether the nickel felt 11 inserted in the fuel cell is properly brought into contact with internal electrodes of the fuel electrode. Furthermore, although the nickel ink 14 contributes to the contact between the nickel felt 11 and the internal electrodes of the fuel cell to some degree, the fuel cell is difficult to be completely brought into contact with a current collector because the nickel ink 14 becomes hard for a short period of time. In conclusion, the conventional internal current collecting method of a tubular solid oxide fuel cell is problematic in that process efficiency is decreased and in that complete current collection cannot be realized.

### SUMMARY OF THE INVENTION

Accordingly, the present invention has been made to solve the above-mentioned problems, and the present invention provides a solid oxide fuel cell which can easily collect the electric current generated from internal electrodes through a manifold without using an additional current collector by employing metal foam and metal tube.

An aspect of the present invention provides a solid oxide fuel cell, including: one or more unit cells, each being provided with a ceramic tubular support; a metal layer which is formed on an outer circumference of one end of each of the unit cells and collects a first electric current; a metal foam which is formed in each of the unit cells and collects a second electric current; and a manifold which is connected with one end of each of the unit cells to receive the first current collected in the metal layer and which is connected with the other end of each of the unit cells to receive the second current collected in the metal foam.

Here, the solid oxide fuel cell may further include: a metal tube whose one end is inserted in an inner circumference of the metal foam and whose other end is connected with the manifold to electrically connect the metal foam with the manifold.

Further, the metal foam may extend from an inside of the unit cell to an outer circumference of the other end of the unit cell.

Further, the manifold may include a gas supply unit and a gas discharge unit, the number of the unit cells may be two or more, and one end of the unit cell may be connected to the gas supply unit and the other end of the unit cell may be connected to the gas discharge unit such that the unit cells are connected in parallel to each other.

Further, the manifold may include a gas supply unit and a gas discharge unit, the number of the unit cells may be two or more, and the other end of the unit cell may be connected to the gas supply unit and one end of the unit cell may be connected to the gas discharge unit such that the unit cells are connected in parallel to each other.

Further, the manifold may include a gas supply unit, one or more gas communication units and a gas discharge unit, the number of the unit cells may be two or more, and one end of one unit cell may be connected to the gas supply unit, the other end of another unit cell may be connected to the gas discharge unit, and one end and the other end of the two adjacent unit cells may be connected to the gas communication unit such that the unit cells are connected in series to each other.

Further, the manifold may include a gas supply unit, one or more gas communication units and a gas discharge unit, the number of the unit cells may be two or more, and the other end of one unit cell may be connected to the gas supply unit, one end of another unit cell may be connected to the gas discharge unit, and one end and the other end of the two adjacent unit cells may be connected to the gas communication unit such that the unit cells are connected in series to each other.

Further, the unit cell may include an anode tubular support as the ceramic tubular support, and the anode tubular support may be sequentially provided on an outer circumference thereof with an electrolyte and a cathode, so that the metal layer collects positive current and the metal foam collects negative current, and the manifold supplies fuel into the anode tubular support.

Further, the cathode formed at the other end of the unit cell may be removed, and the other end of the unit cell may be connected with the manifold through brazing using a metal filler.

Further, the unit cell may include a cathode tubular support as the ceramic tubular support, and the cathode tubular support may be sequentially provided on an outer circumference thereof with an electrolyte and an anode, so that the metal layer collects negative current and the metal foam collects positive current, and the manifold supplies air or oxygen into the cathode tubular support.

Further, the anode formed at the other end of the unit cell may be removed, and the other end of the unit cell may be connected with the manifold through brazing using a metal filler.

Further, one end of the unit cell may be connected with the manifold through brazing using a metal filler.

Further, the metal tube may be made of stainless steel.

Further, the metal tube may be made of a porous material.

Further, only one end of the metal tube, inserted in the inner circumference of the metal foam, may be selectively made of a porous material.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional internal current collecting method of a tubular solid oxide fuel cell;

FIGS. 2 and 3 are perspective views showing unit cells according to an embodiment of the present invention;

FIGS. 4 and 5 are perspective views showing unit cells according to another embodiment of the present invention;

FIGS. 6 to 9 are sectional views showing solid oxide fuel cells according to a first embodiment of the present invention;

FIGS. 10 to 13 are sectional views showing solid oxide fuel cells according to a second embodiment of the present invention; and

FIGS. 14 to 17 are sectional views showing solid oxide fuel cells according to a third embodiment of the present invention;

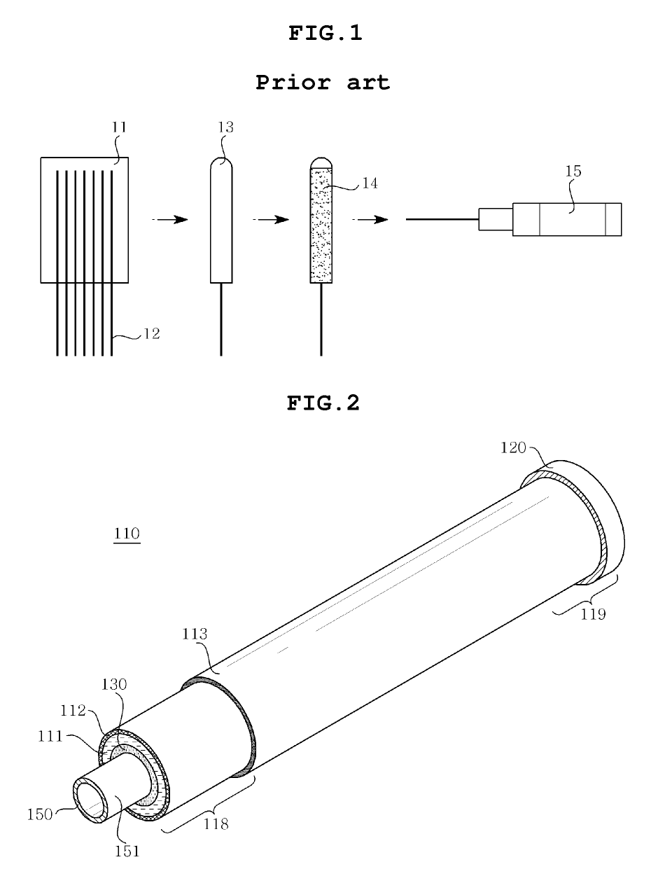

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, O₂ and H₂ shown in the drawings are set forth to concretely explain the operation of a fuel cell, but the kind of gas supplied to the anode or cathode is not limited thereto. Further, the terms “one end”, “the other end”, “first”, “second”, “inside”, “outside” and the like are used to differentiate a certain component from other components, but the configuration of such components should not be construed to be limited by the terms. Furthermore, in the description of the present invention, when it is determined that the detailed description of the related art would obscure the gist of the present invention, the description thereof will be omitted.

Hereinafter, preferred embodiments of the present invention will be described in detail with reference to the attached drawings.

A solid oxide fuel cell according to the present invention is shown based on a fuel cell using an anode tubular support 111 or a cathode tubular support 115, but is not limited thereto. That is, a fuel cell including an additional ceramic support laminated on the outer circumference thereof with an anode 117, an electrolyte 112 and a cathode 113 is also included on the scope of the present invention.

The solid oxide fuel cell according to the present invention includes one or more unit cells 110, each being provided with a ceramic tubular support, a metal layer 120 which is formed on the outer circumference of one end of each of the unit cells 110 and collects a first electric current, a metal foam 130 which is formed in each of the unit cells 110 and collects a second electric current, and a manifold 140 which is connected with one end 119 of each of the unit cells 110 to receive the first current collected in the metal layer 120 and which is connected with the other end 118 of each of the unit cells 110 to receive the second current collected in the metal foam 130.

Since the present invention is configured by the combination of one or more unit cells 110 and a manifold 140, first, the structure of one unit cell 110 is explained in detail, and then the structure in which the one or more unit cells 110 are combined with the manifold 140 will be described.

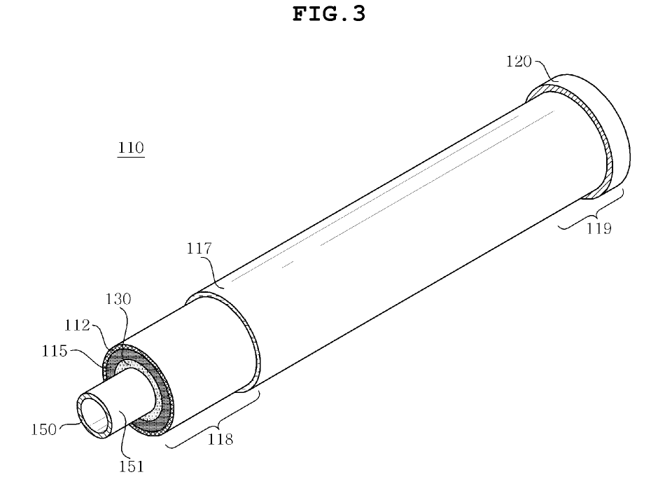

FIGS. 2 and 3 are perspective views showing unit cells according to an embodiment of the present invention.

As shown in FIG. 2, a unit cell 110 includes an anode tubular support 111, an electrolyte 112 and a cathode 113, which are essential elements necessary for producing an electric current. In this case, the anode tubular support 111 may be formed through general extrusion molding. The anode tubular support 111 is sequentially provided on the outer circumference thereof with the electrolyte 112 and the cathode 113 to form the unit cell 110. In the unit cell 110, since an internal electrode is an anode, fuel is supplied from the manifold 140 to the inside of the unit cell 110, and an oxidation atmosphere is created to the outside of the unit cell 110.

Further, one end of the unit cell 110 and the other end of the unit cell 100 are respectively connected to the manifold 140. At one end 119 of the unit cell 110, a metal layer 120 transfers a positive current to the manifold 140, and, at the other end 118 of the unit cell 110, metal foam 130 and one end 151 of a metal tube 150 transfer a negative current to the manifold 140. In this case, at the other end 118 of the unit cell 110, since the negative current produced in the anode tubular support 111 is transferred to the manifold 140 through the metal foam 130 and one end 151 of a metal tube 150, a short occurs when the positive current produced in the cathode 113 is transferred to the manifold 140 connected with the other end 118 of the unit cell 110. Therefore, as shown in FIG. 2, it is preferred that the cathode 113 formed at the other end 18 of the unit cell be removed.

The unit cell 110 is provided therein with the metal foam 130 for collecting the negative current produced in the anode tubular support 111 and one end of the metal tube 150 as constituents for electric current collection.

The metal foam 130 is advantageous in that it can be easily inserted into the unit cell 110 because it can be integrally formed without performing complicated processes, and it has a high current collecting efficiency because it has retractility and thus completely comes into contact with an internal electrode. Further, the metal foam 130 is advantageous in that it can easily transfer the gas supplied from the manifold 140 to the internal electrode because it is made of a porous material. The metal foam 130 may be made of any one selected from among Ni-doped zirconia cement, Ni-doped CeO₂ cement, Cu-doped ceria cermet, silver-(Bi—Sr—Ca—Cu—O)-oxide cement, silver-(Y—Ba—Cu—O)-oxide cement, silver-alloy-(Bi—Sr—Ca—Cu—O)-oxide cement, silver-alloy-(YBa—Cu—O)-oxide cement, silver and alloys thereof, Inconel steel and cemented carbides, ferritic steel, SiC or MoSi₂, and the like, but the present invention is not limited thereto. The metal foam 130 may include all electroconductive metal foams.

The metal tube 150 includes one end inserted in the inner circumference of the metal foam 130 and the other end 151 connected to the manifold 140, and serves to transfer the electric current collected in the metal foam 130 to the manifold 140. The metal tube 150 may be integrally formed together with the manifold 140, or may be integrated with the manifold 140 by separately forming the metal tube 150 and then attaching the metal tube 150 to the manifold 140 through a welding process. The metal tube 150 not only serves to transfer the electric current collected in the metal foam 130 to the manifold 140 but also serves to increase an electric current collecting efficiency by pressurizing the metal foam 130 toward the internal electrode. Considering that the solid oxide fuel is operated at high temperature, the metal tube 150 may be made of, but is not limited to, stainless steel having excellent high-temperature oxidation resistance and high heat resistance. Further, the metal tube 150 may be made of a porous material such that the gas supplied from the manifold 140 is transferred to the metal foam 130. However, since the gas supply efficiency of the metal tube 150 is decreased when the other end 151 of the metal tube 150, protruding toward the outside of the unit cell 110, is also made of a porous material, it is preferred that only one end of the metal tube 150, inserted in the inner circumference of the metal foam 130, be selectively made of a porous material.

The unit cell 110 is provided on the outer circumference thereof with a metal layer 120 for collecting the positive current produced in the cathode 113. The metal layer 120 is provided on one end 119 of the unit cell 110, and is attached to the manifold 140. Since the metal layer 120 is made of the same metal as the manifold 140, the metal layer 120 is easily brazed and can be stably attached to the manifold 140. The metal layer 120 may be made of any one selected from the group consisting of iron (Fe), copper (Cu), aluminum (Al), nickel (Ni), chromium (Cr), and alloys and combinations thereof, but the present invention is not limited thereto.

As shown in FIG. 3, a unit cell 110 includes a cathode tubular support 115, an electrolyte 112 and an anode 117, which are essential elements necessary for producing an electric current. In this case, the cathode tubular support 115 may be formed through general extrusion molding. The cathode tubular support 115 is sequentially provided on the outer circumference thereof with the electrolyte 112 and the anode 117 to form the unit cell 110. Comparing this unit cell with the unit cell shown in FIG. 2, the positions at which the anode and cathode are formed have been interchanged. In the unit cell 110, since an internal electrode is a cathode, air or oxygen is supplied from the manifold 140 to the inside of the unit cell 110, and a reduction atmosphere is created outside of the unit cell 110.

Further, one end of the unit cell 110 and the other end of the unit cell 100 are respectively connected to the manifold 140. At one end 119 of the unit cell 110, a metal layer 120 transfers a negative current to the manifold 140, and, at the other end 118 of the unit cell 110, a metal foam 130 and one end 151 of a metal tube 150 transfer a positive current to the manifold 140. In this case, at the other end 118 of the unit cell 110, since the positive current produced in the cathode tubular support 115 is transferred to the manifold 140 through the metal foam 130 and the metal tube 150, a short occurs when the negative current produced in the anode 117 is transferred to the manifold 140 connected with the other end 118 of the unit cell 110. Therefore, as shown in FIG. 3, it is preferred that the anode 117 formed at the other end 18 of the unit cell be removed.

Meanwhile, sine the positions and components of the metal layer 120, the metal foam 130 and the metal tube 150 of this unit cell are the same as those of the unit cell shown in FIG. 2, detailed description thereof will be omitted.

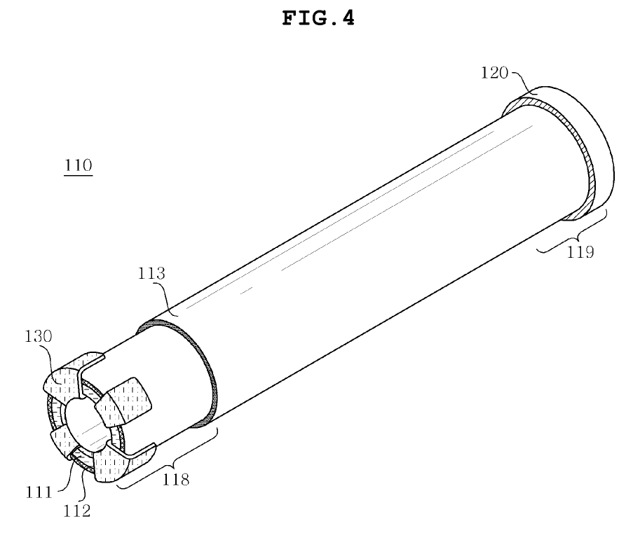

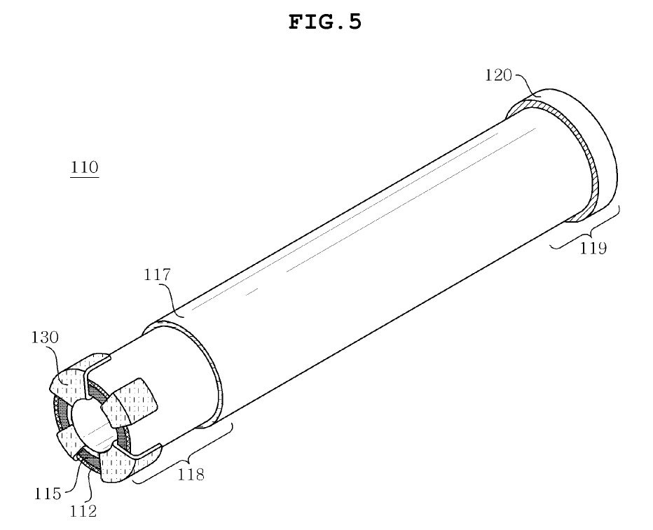

FIGS. 4 and 5 are perspective views showing unit cells according to another embodiment of the present invention.

The unit cells shown in FIGS. 4 and 5 are different from the unit cells shown in FIGS. 2 and 3 as concerns the presence or absence of a metal tube 150. Since each of the unit cells shown in FIGS. 4 and 5 does not include the metal tube 150, the production cost thereof can be decreased. Further, in each of the unit cells shown in FIGS. 4 and 5, since the metal foam 130 extends from the inside of the unit cell 110 to the outer circumference of the other end 118 of the unit cell 110, the unit cell 110 can effectively transfer an electric current to the manifold 140. The unit cell 110 shown in FIG. 4 uses an anode tubular support 111, and the unit cell 110 shown in FIG. 5 uses a cathode tubular support 115. Since other constituents of the unit cells shown in FIGS. 4 and 5 are the same as those of the unit cells shown in FIGS. 2 and 3 except for the metal tube 150, detailed description thereof will be omitted.

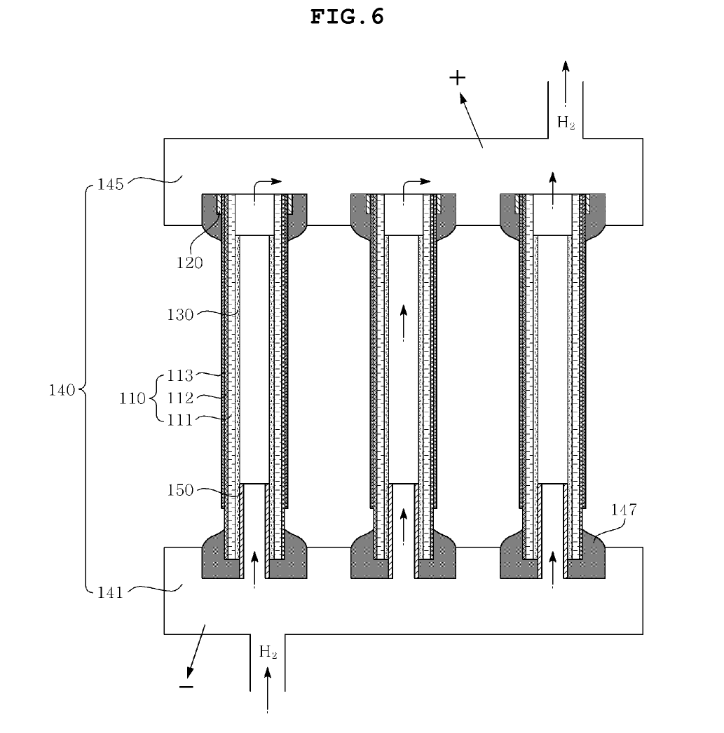

FIGS. 6 to 9 are sectional views showing solid oxide fuel cells according to a first embodiment of the present invention.

As shown in FIGS. 6 to 9, each of the solid oxide fuel cells according to a first embodiment of the present invention collects electric current using unit cells 110, each including a metal layer 120, metal foam 130 and a metal tube 150. The unit cells 110 are connected in parallel to a manifold 140. The manifold 140 includes a gas supply unit 141 for supplying gas (fuel or air) and a gas discharge unit 145 for discharging gas. One end 119 of each of the unit cells 110 and the other end 118 of each of the unit cells 110 are connected to the gas supply unit 141 and the gas discharge unit 145, respectively. Further, as described above, at one end 119 of each of the unit cells 110, the metal layer 120 transfers an electric current to the manifold 140, and, at the other end 118 of each of the unit cells 110, the metal foam 130 and the metal tube 150 transfer an electric current to the manifold 140.

The unit cells 110 are connected with the manifold 140 through brazing using metal fillers 147. In this case, as described above, an outer electrode (anode or cathode) formed at the other end 118 of each of the unit cells 110 must be removed to prevent a short from occurring.

The solid oxide fuel cell shown in FIG. 6 collects an electric current by connecting the unit cells 110, each being provided with an anode tubular support 111, to the manifold 140. One end 119 of each of the unit cells 110 is connected to the gas discharge unit 145 of the manifold 140, and the other end 118 of each of the unit cells 110 is connected to the gas supply unit 141 of the manifold 140. Further, since the anode tubular support 111 is used, the gas supply unit 141 supplies fuel to the unit cells 110, and an oxidation atmosphere is created to the outside of the unit cells 110. Further, since an internal electrode is an anode, the metal foam 130 and metal tube 150 collect a negative current and then transfer the collected negative current to the gas supply unit 141. Furthermore, since an external electrode is a cathode, the metal layer 120 collects a positive current and then transfers the collected positive current to the gas discharge unit 145. In conclusion, the negative current can be obtained from the gas supply unit 141, and the positive current can be obtained from the gas discharge unit 145.

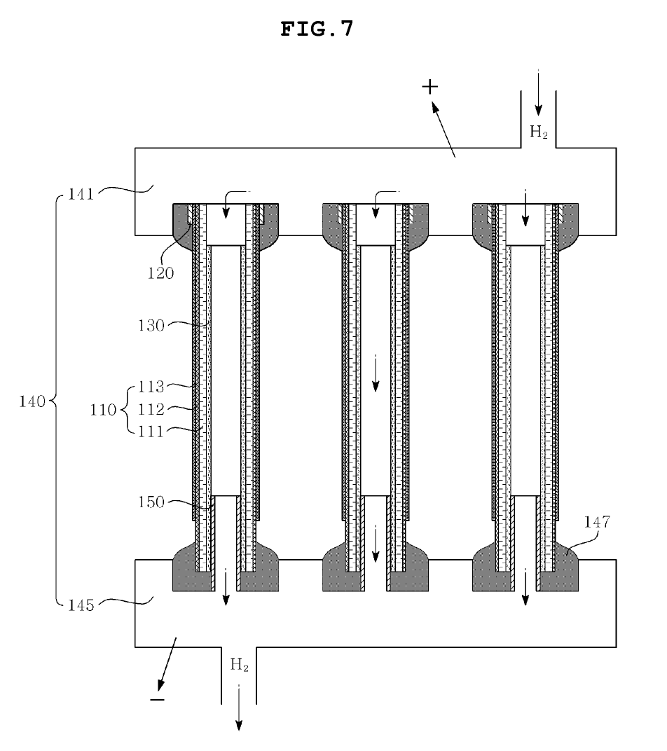

The solid oxide fuel cell shown in FIG. 7 collects electric current by connecting the unit cells 110, each being provided with an anode tubular support 111, to the manifold 140. The other end 118 of each of the unit cells 110 is connected to the gas discharge unit 145 of the manifold 140, and one end 119 of each of the unit cells 110 is connected to the gas supply unit 141 of the manifold 140. That is, comparing this solid oxide fuel cell with the solid oxide fuel cell shown in FIG. 6, the positions of the gas supply unit 141 and the gas discharge unit 145 have been interchanged. Therefore, positive current can be obtained from the gas supply unit 141, and negative current can be obtained from the gas discharge unit 145.

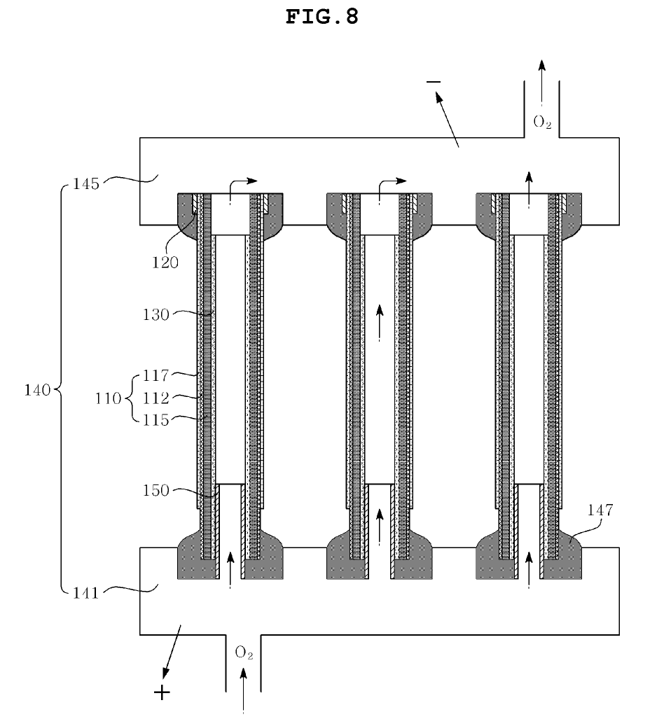

The solid oxide fuel cell shown in FIG. 8 collects electric current by connecting the unit cells 110, each being provided with a cathode tubular support 115, to the manifold 140. One end 119 of each of the unit cells 110 is connected to the gas discharge unit 145 of the manifold 140, and the other end 118 of each of the unit cells 110 is connected to the gas supply unit 141 of the manifold 140. Further, since the cathode tubular support 115 is used, the gas supply unit 141 supplies air or oxygen to the unit cells 110, and a reduction atmosphere is created outside of the unit cells 110. Further, since an internal electrode is a cathode, metal foam 130 and metal tube 150 collect a positive current and then transfer the collected positive current to the gas supply unit 141. Furthermore, since the external electrode is an anode, the metal layer 120 collects a negative current and then transfers the collected negative current to the gas discharge unit 145. In conclusion, the positive current can be obtained from the gas supply unit 141, and the negative current can be obtained from the gas discharge unit 145.

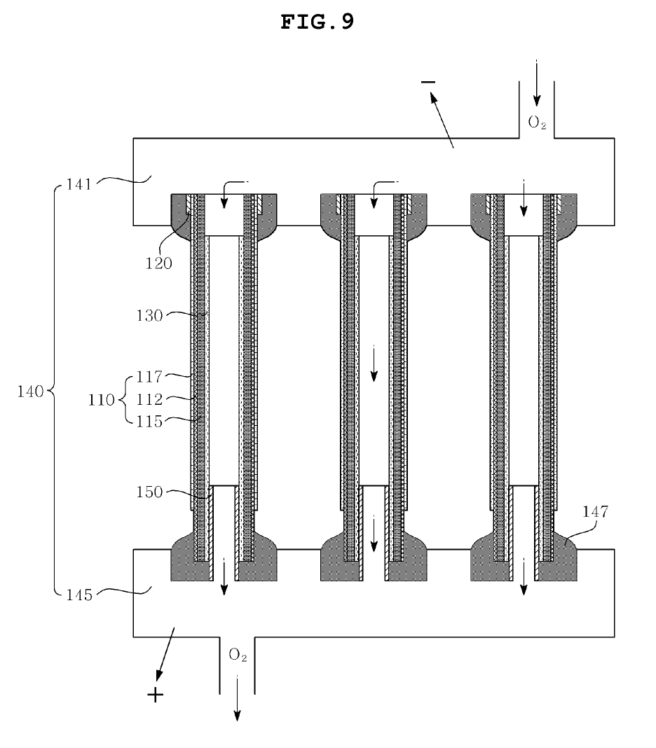

The solid oxide fuel cell shown in FIG. 9 collects an electric current by connecting the unit cells 110, each being provided with a cathode tubular support 115, to the manifold 140. The other end 118 of each of the unit cells 110 is connected to the gas discharge unit 145 of the manifold 140, and one end 119 of each of the unit cells 110 is connected to the gas supply unit 141 of the manifold 140. That is, comparing this solid oxide fuel cell with the solid oxide fuel cell shown in FIG. 8, the positions of the gas supply unit 141 and the gas discharge unit 145 have been interchanged. Therefore, the negative current can be obtained from the gas supply unit 141, and the positive current can be obtained from the gas discharge unit 145.

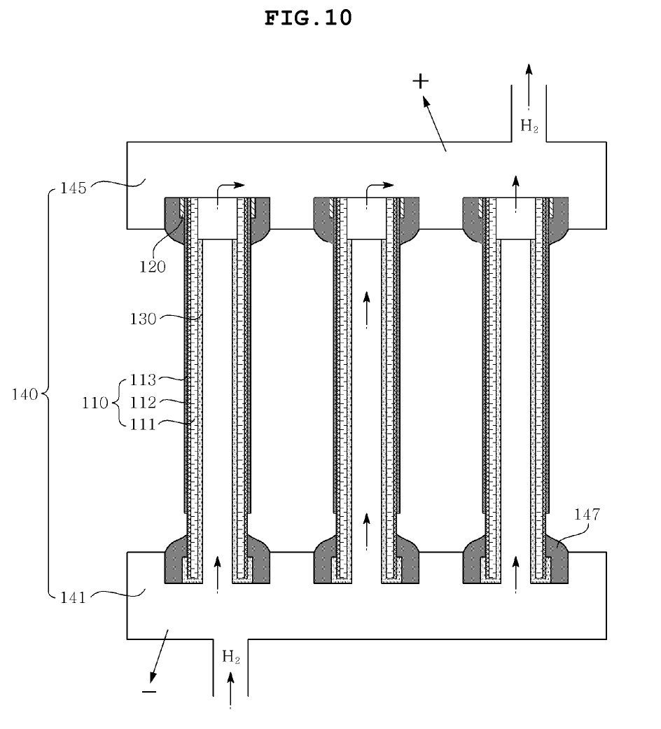

FIGS. 10 to 13 are sectional views showing solid oxide fuel cells according to a second embodiment of the present invention.

As shown in FIGS. 10 to 13, each of the solid oxide fuel cells according to a second embodiment of the present invention collects electric current using unit cells 110, each including a metal layer 120 and metal foam 130. The unit cells 110 are connected in parallel to a manifold 140. Comparing the solid oxide fuel cells according to the second embodiment of the present invention with the solid oxide fuel cells according to the first embodiment of the present invention, the solid oxide fuel cells according to the second embodiment of the present invention maintain a current collecting efficiency by extending the metal foam 130 from the inside of the unit cell 110 to the outer circumference of the other end 118 of the unit cell 110 (refer to FIGS. 4 and 5) and thus bringing the metal foam 130 into contact with the metal filler 147 such that the contact area therebetween is maximized, instead of not using the metal tube 150. Since other constituents of the solid oxide fuel cells according to the second embodiment of the present invention are the same as those of the solid oxide fuel cell according to the first embodiment of the present invention except for the metal tube 150, detailed description thereof will be omitted.

The solid oxide fuel cell shown in FIG. 10 collects an electric current by connecting the unit cells 110, each being provided with an anode tubular support 111, to the manifold 140. One end 119 of each of the unit cells 110 is connected to the gas discharge unit 145 of the manifold 140, and the other end 118 of each of the unit cells 110 is connected to the gas supply unit 141 of the manifold 140. Further, since the anode tubular support 111 is used, the gas supply unit 141 supplies fuel to the unit cells 110, and an oxidation atmosphere is created outside of the unit cells 110. Further, since an internal electrode is an anode, the metal foam 130 collects a negative current and then transfer the collected negative current to the gas supply unit 141. Furthermore, since an external electrode is a cathode, the metal layer 120 collects a positive current and then transfers the collected positive current to the gas discharge unit 145. In conclusion, the negative current can be obtained from the gas supply unit 141, and the positive current can be obtained from the gas discharge unit 145.

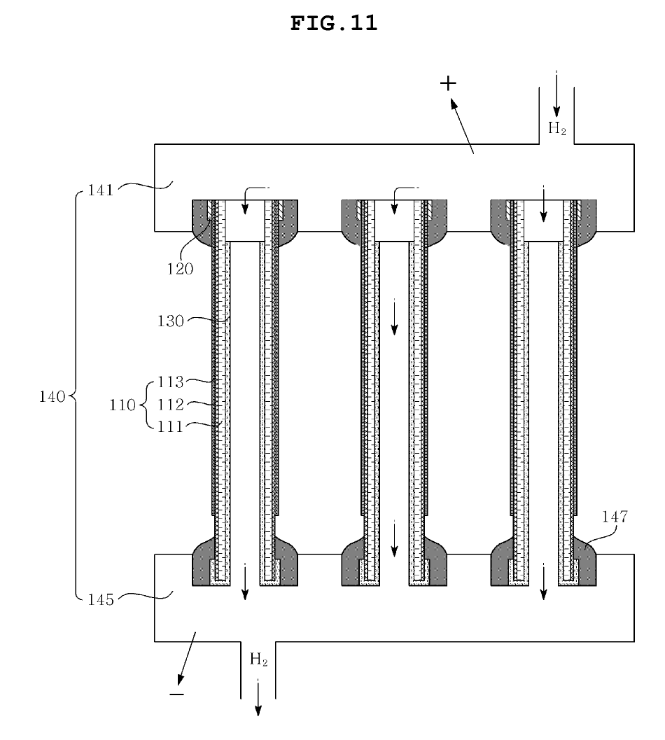

The solid oxide fuel cell shown in FIG. 11 collects an electric current by connecting the unit cells 110, each being provided with an anode tubular support 111, to the manifold 140. The other end 118 of each of the unit cells 110 is connected to the gas discharge unit 145 of the manifold 140, and one end 119 of each of the unit cells 110 is connected to the gas supply unit 141 of the manifold 140. That is, comparing this solid oxide fuel cell with the solid oxide fuel cell shown in FIG. 10, the positions of the gas supply unit 141 and the gas discharge unit 145 have been interchanged. Therefore, the positive current can be obtained from the gas supply unit 141, and the negative current can be obtained from the gas discharge unit 145.

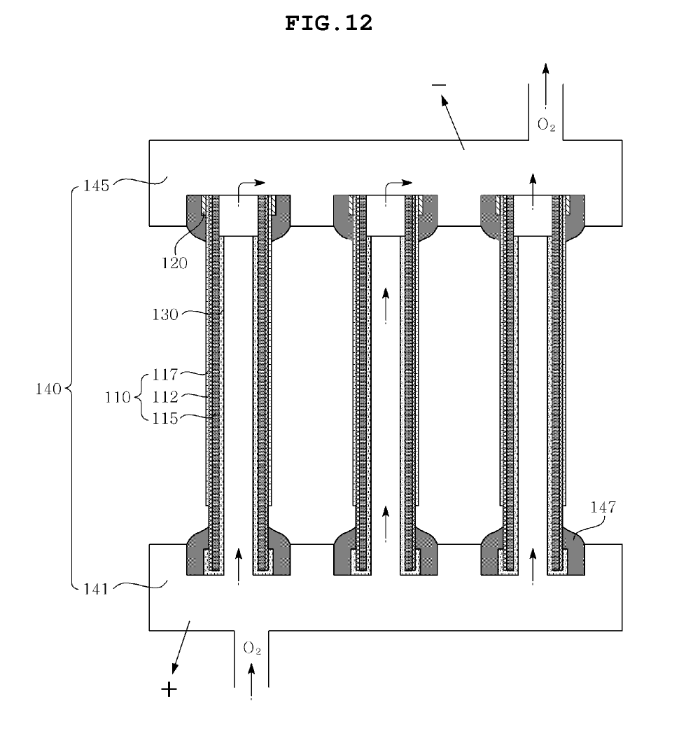

The solid oxide fuel cell shown in FIG. 12 collects electric current by connecting the unit cells 110, each being provided with a cathode tubular support 115, to the manifold 140. One end 119 of each of the unit cells 110 is connected to the gas discharge unit 145 of the manifold 140, and the other end 118 of each of the unit cells 110 is connected to the gas supply unit 141 of the manifold 140. Further, since the cathode tubular support 115 is used, the gas supply unit 141 supplies air or oxygen to the unit cells 110, and a reduction atmosphere is created outside of the unit cells 110. Further, since an internal electrode is a cathode, the metal foam 130 and metal tube 150 collect a positive current and then transfer the collected positive current to the gas supply unit 141. Furthermore, since an external electrode is an anode, the metal layer 120 collects a negative current and then transfers the collected negative current to the gas discharge unit 145. In conclusion, the positive current can be obtained from the gas supply unit 141, and the negative current can be obtained from the gas discharge unit 145.

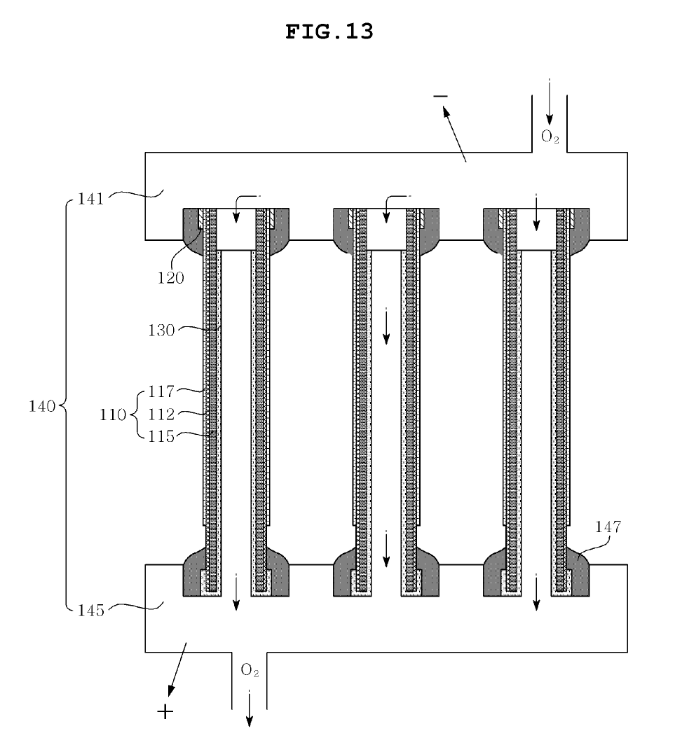

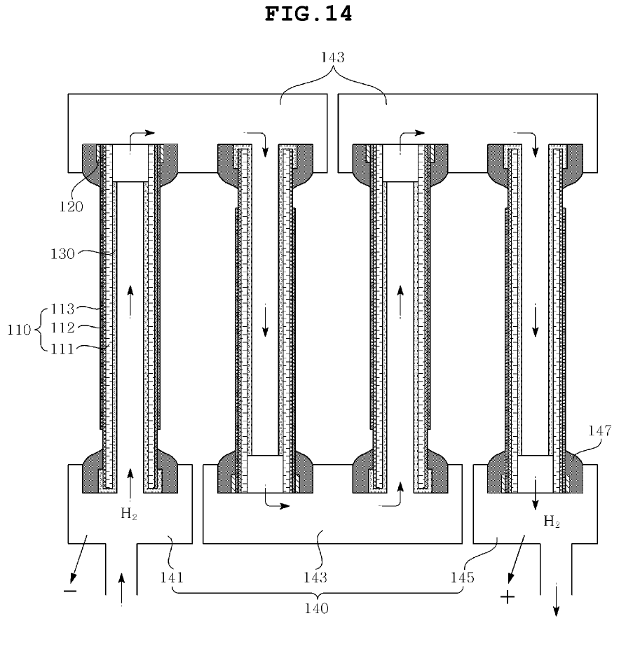

The solid oxide fuel cell shown in FIG. 13 collects an electric current by connecting the unit cells 110, each being provided with a cathode tubular support 115, to the manifold 140. The other end 118 of each of the unit cells 110 is connected to the gas discharge unit 145 of the manifold 140, and one end 119 of each of the unit cells 110 is connected to the gas supply unit 141 of the manifold 140. That is, comparing this solid oxide fuel cell with the solid oxide fuel cell shown in FIG. 12, the positions of the gas supply unit 141 and the gas discharge unit 145 are changed each other. Therefore, the negative current can be obtained from the gas supply unit 141, and the positive current can be obtained from the gas discharge unit 145.

Although the solid oxide fuel cells according to the first and second embodiments of the present invention have been explained based on a plurality of unit cells 110 connected in parallel to each other, the present invention is not limited thereto. Solid oxide fuel cells in which each single unit cell is connected with a manifold to collect an electric current are also included in the scope of the present invention.

FIGS. 14 to 17 are sectional views showing solid oxide fuel cells according to a third embodiment of the present invention.

The solid oxide fuel cells according to the third embodiment of the present invention are different from the solid oxide fuel cells according to the first and second embodiments of the present invention because a plurality of unit cells is connected in series to each other. The manifold 140, differently from the manifold of the solid oxide fuel cells according to the first and second embodiments of the present invention, further includes a gas communication unit 143 in addition to the gas supply unit 141 and the gas discharge unit 145. The end and opposite end of each of the unit cells are disposed in opposition to those of the unit cell adjacent to the unit cell. Here, the end and opposite end of two adjacent unit cells 100 are respectively connected to the gas communication unit 143, so that gas (fuel or air) can flow between the two unit cells 110, and the two adjacent unit cells 110 are connected in series to each other through the gas communication unit 143.

The solid oxide fuel cell shown in FIG. 14 collects an electric current by connecting the unit cells 110, each being provided with an anode tubular support 111, in series to the manifold 140. Among the plurality of unit cells 110, the other end 118 of one unit cell is connected to the gas supply unit 141 of the manifold 140, and one end 119 of another unit cell is connected to the gas discharge unit 145. Further, the end and opposite end of two adjacent unit cells 110 are respectively connected to the gas communication unit 143, so that the two adjacent unit cells 110 are connected in series to each other. Since an internal electrode is the anode tubular support 111, the negative current of the serially connected unit cells 110 is transferred to the gas supply unit 141 through the metal foam 130, and the positive current of the serially connected unit cells 110 is transferred to the gas discharge unit 145 through the metal layer 120. In this solid oxide fuel cell, since the unit cells are serially connected, current intensity is relatively low compared to when the unit cells are connected in parallel, power loss caused by electrical resistance can be decreased.

Meanwhile, since an internal electrode is the anode tubular support 111, the gas supply unit 141 supplies fuel to one unit cell 110, and the supplied fuel is transferred to an adjacent unit cell 110 through the gas communication unit 143 and then finally discharged through the gas discharge unit 145.

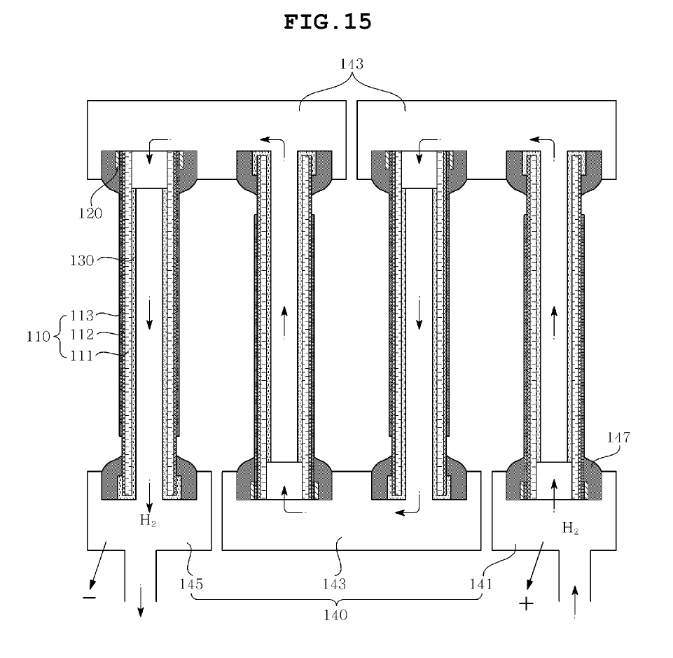

The solid oxide fuel cell shown in FIG. 15 collects an electric current by connecting in series the unit cells 110, each being provided with an anode tubular support to 111, to the manifold 140. Comparing this solid oxide fuel cell with the solid oxide fuel cell shown in FIG. 14, the positions of the gas supply unit 141 and the gas discharge unit 145 have been interchanged. Therefore, the negative current of the serially connected unit cells 110 is transferred to the gas discharge unit 145 through the metal foam 130, and the positive current of the serially connected unit cells 110 is transferred to the gas supply unit 141 through the metal layer 120.

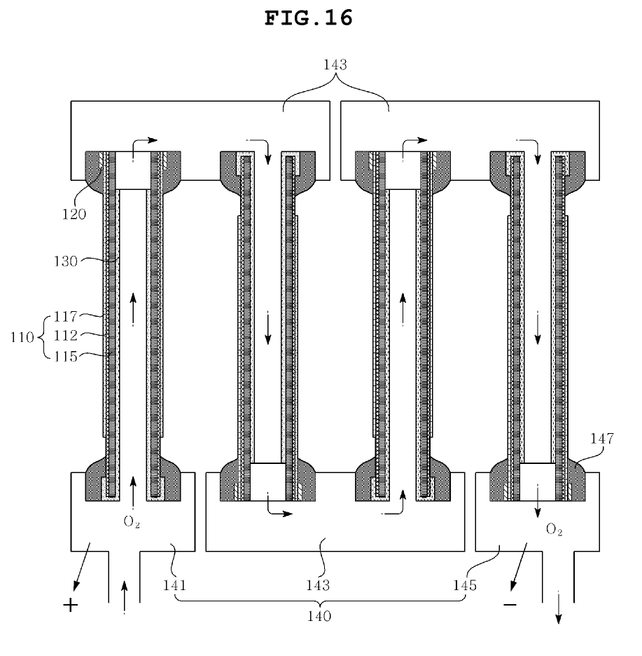

The solid oxide fuel cell shown in FIG. 16 collects an electric current by connecting in series the unit cells 110, each being provided with a cathode tubular support 115, to the manifold 140. Among the plurality of unit cells 110, the other end 118 of one unit cell is connected to the gas supply unit 141 of the manifold 140, and one end 119 of another unit cell is connected to the gas discharge unit 145. Further, the end and opposite end of two adjacent unit cells 110 are respectively connected to the gas communication unit 143, so that the two adjacent unit cells 110 are connected in series to each other. Since an internal electrode is the cathode tubular support 115, the positive current of the serially connected unit cells 110 is transferred to the gas supply unit 141 through the metal foam 130, and the negative current of the serially connected unit cells 110 is transferred to the gas discharge unit 145 through the metal layer 120.

Meanwhile, since an internal electrode is the cathode tubular support 115, the gas supply unit 141 supplies air or oxygen to one unit cell 110, and the supplied air or oxygen is transferred to an adjacent unit cell 110 through the gas communication unit 143 and then finally discharged through the gas discharge unit 145.

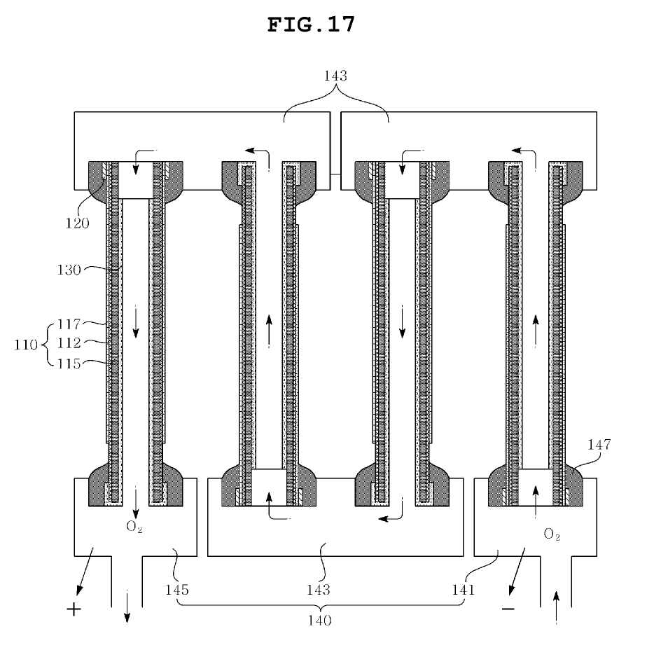

The solid oxide fuel cell shown in FIG. 17 collects electric current by connecting the unit cells 110 in series, each being provided with a cathode tubular support 115, to the manifold 140. Comparing this solid oxide fuel cell with the solid oxide fuel cell shown in FIG. 16, the positions of the gas supply unit 141 and the gas discharge unit 145 have been interchanged with each other. Therefore, the positive current of the serially connected unit cells 110 is transferred to the gas discharge unit 145 through the metal foam 130, and the negative current of the serially connected unit cells 110 is transferred to the gas supply unit 141 through the metal layer 120.

In the third embodiment of the present invention, the unit cells 110, each being provided with only the metal foam 130, are used, but the present invention is not limited thereto. Methods of connecting the unit cells 110 in series by inserting the metal tube 150 into the inner circumference of the metal foam 130 are also included in the scope of the present invention.

As described above, according to the present invention, since metal foam and a metal tube are employed, an additional current collector is not required, and the electric current generated from an internal electrode can be easily collected through a manifold by connecting the metal foam and metal tube with the manifold. Further, since the metal foam is porous, the gas (fuel or air) supplied to the inside of the fuel cell can be easily transferred to the internal electrode. Since the metal tube completely brings the metal foam into contact with the internal electrode by pressurizing the metal foam toward the internal electrode of the fuel cell, the current collecting efficiency of the fuel cell can be increased even more.

Further, according to the present invention, since a metal layer is formed on the outer circumference of each of the unit cells of the fuel cell, an additional current collector is not required, and the electric current generated from an external electrode can be easily collected by connecting the metal layer with a manifold.

Furthermore, according to the present invention, when a plurality of unit cells is connected with each other to form a bundle, electric current can be collected at one time using a manifold, and an additional process of connecting the unit cells is not required, so that a process of fabricating a solid oxide fuel cell is simplified and the bundle can be miniaturized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A solid oxide fuel cell, comprising:
one or more unit cells, each being provided with a ceramic tubular support;
a metal layer which is formed on an outer circumference of one end of each of the unit cells and collects a first electric current;
a metal foam which is formed in each of the unit cells and collects a second electric current; and
a manifold which is connected with one end of each of the unit cells to receive the first current collected in the metal layer and which is connected with the other end of each of the unit cells to receive the second current collected in the metal foam.

2. The solid oxide fuel cell according to claim 1, further comprising: a metal tube whose one end is inserted in an inner circumference of the metal foam and whose the other end is connected with the manifold to electrically connect the metal foam with the manifold.

3. The solid oxide fuel cell according to claim 1, wherein the metal foam extends from an inside of the unit cell to an outer circumference of the other end of the unit cell.

4. The solid oxide fuel cell according to claim 1,
wherein the manifold includes a gas supply unit and a gas discharge unit,
the number of the unit cells is two or more, and
one end of the unit cell is connected to the gas supply unit and the other end of the unit cell is connected to the gas discharge unit such that the unit cells are connected in parallel to each other.

5. The solid oxide fuel cell according to claim 1,
wherein the manifold includes a gas supply unit and a gas discharge unit,
the number of the unit cells is two or more, and
the other end of the unit cell is connected to the gas supply unit and one end of the unit cell is connected to the gas discharge unit such that the unit cells are connected in parallel to each other.

6. The solid oxide fuel cell according to claim 1,
wherein the manifold includes a gas supply unit, one or more gas communication units and a gas discharge unit,
the number of the unit cells is two or more, and
one end of one unit cell is connected to the gas supply unit, the other end of another unit cell is connected to the gas discharge unit, and one end and the other end of the two adjacent unit cells are connected to the gas communication unit such that the unit cells are connected in series to each other.

7. The solid oxide fuel cell according to claim 1,
wherein the manifold includes a gas supply unit, one or more gas communication units and a gas discharge unit,
the number of the unit cells is two or more, and
the other end of one unit cell is connected to the gas supply unit, one end of another unit cell is connected to the gas discharge unit, and one end and the other end of the two adjacent unit cells are connected to the gas communication unit such that the unit cells are connected in series to each other.

8. The solid oxide fuel cell according to claim 1,
wherein the unit cell includes an anode tubular support as the ceramic tubular support, and the anode tubular support is sequentially provided on an outer circumference thereof with an electrolyte and a cathode, so that the metal layer collects positive current and the metal foam collects negative current, and
the manifold supplies fuel into the anode tubular support.

9. The solid oxide fuel cell according to claim 8, wherein the cathode formed at the other end of the unit cell is removed, and the other end of the unit cell is connected with the manifold through brazing using a metal filler.

10. The solid oxide fuel cell according to claim 1,
wherein the unit cell includes a cathode tubular support as the ceramic tubular support, and the cathode tubular support is sequentially provided on an outer circumference thereof with an electrolyte and an anode, so that the metal layer collects negative current and the metal foam collects positive current, and
the manifold supplies air or oxygen into the cathode tubular support.

11. The solid oxide fuel cell according to claim 10, wherein the anode formed at the other end of the unit cell is removed, and the other end of the unit cell is connected with the manifold through brazing using a metal filler.

12. The solid oxide fuel cell according to claim 1, wherein the other end of the unit cell is connected with the manifold through brazing using a metal filler.

13. The solid oxide fuel cell according to claim 2, wherein the metal tube is made of stainless steel.

14. The solid oxide fuel cell according to claim 2, wherein the metal tube is made of a porous material.

15. The solid oxide fuel cell according to claim 2, wherein only one end of the metal tube, inserted in the inner circumference of the metal foam, is selectively made of a porous material.
